(19) United States
(12) Patent Application Publication
(10) Pub. No.: US 2018/0314224 A1
(43) Pub. Date: Nov. 1, 2018

(54) LADDER PROGRAM EDITOR

(71) Applicant: FANUC CORPORATION, Yamanashi (JP)

(72) Inventors: Toshiyuki Matsuo, Yamanashi (JP); Mitsuru Mochizuki, Yamanashi (JP)

(73) Assignee: FANUC CORPORATION, Yamanashi (JP)

(21) Appl. No.: 15/965,312

(22) Filed: Apr. 27, 2018

(30) Foreign Application Priority Data
May 1, 2017 (JP) 2017-091205

(51) Int. Cl. G05B 19/05

(52) U.S. Cl. CPC G05B 19/056; G05B 2219/13041; G05B 2219/13144; G05B 2219/13046

(57) ABSTRACT

Provided is a ladder program editor capable of appropriately pasting a partial circuit on a ladder program displayed on a screen, based on display elements of the ladder program. The ladder program editor is provided with an editing control unit configured to manage a virtual drawing area formed as a set of a plurality of rectangular areas, a pasting object specifying unit configured to specify a partial circuit as an object of pasting, a reference area specifying unit configured to specify a reference area to serve as a reference for pasting the partial circuit, a pasting method specifying unit configured to specify a pasting position and a pasting method for the partial circuit, a pasting area insertion unit configured to insert a pasting area for pasting the partial circuit into the virtual drawing area, a pasting processing unit configured to paste the partial circuit on the pasting area, and a connecting line adjustment unit configured to adjust connecting lines in the virtual drawing area.

### FIELD OF THE INVENTION

The present invention relates to a ladder program editor, and more particularly, to a ladder program editor capable of pasting a partial circuit on a ladder program.

### DESCRIPTION OF THE RELATED ART

In ladder program editing (including creation of a new ladder program, editing of an existing ladder program, etc.) by means of a ladder program editor, an editing screen for a ladder program is displayed, and a pointing device such as a keyboard or a mouse is operated on the displayed screen to edit the ladder program. A ladder program editing operation includes a so-called pasting operation for a partial circuit, as well as basic operations, such as an operation for arranging contacts and coils and an operation for connecting the arranged contacts and coils, in a ladder circuit included in the ladder program. In the pasting operation, a part of the ladder program (partial circuit of a ladder) displayed on the screen is selected by a rectangle and the selected partial circuit is pasted on another ladder circuit.

In general, the partial circuit pasting operation is achieved by replacing or inserting the selected partial circuit (an element or a set of elements) simply as a figure. FIG. 14 shows an example of a partial circuit pasting operation in prior art ladder program editing. In the ladder program editor, as illustrated in FIG. 14, a screen area for displaying a ladder program, for example, is divided into a plurality of rectangular areas and the ladder program is displayed by drawing elements (contacts, coils, conducting members, etc.) of a ladder circuit individually in the rectangular areas. In this case, in pasting a partial circuit in which two contacts are constructed as an AND circuit on the left side of a specified partial circuit included in the ladder circuit so as to be in AND-relationship with the specified partial circuit, rectangular areas for two columns are inserted into the left side of the specified partial circuit to secure a pasting area of a size that allows the insertion of the partial circuit (procedure 1-1), and the partial circuit is pasted on that one of the inserted rectangular areas which is located on the left side of the specified partial circuit (procedure 1-2).

Moreover, FIG. 15 shows another example of the partial circuit pasting operation in the prior art ladder program editing. As illustrated in FIG. 14, in pasting a partial circuit in which two contacts are constructed as an AND circuit on the lower side of a specified partial circuit included in the ladder circuit so as to be in OR-relationship with the specified partial circuit, a rectangular area for one row and a rectangular area for one column are inserted into the lower and right sides, respectively, of the specified partial circuit to secure a pasting area of a size that allows the insertion of the partial circuit (procedure 2-1), the partial circuit is pasted on that one of the inserted rectangular areas which is located on the lower side of the specified partial circuit (procedure 2-2), and a vertical connecting line is added so that the inserted partial circuit and the specified circuit are connected (procedure 2-3).

Furthermore, FIG. 16 shows another example of the partial circuit pasting operation in the prior art ladder program editing. As illustrated in FIG. 16, in pasting a partial circuit in which two contacts are constructed as an AND circuit on the lower side of a specified partial circuit (three contacts) included in the ladder circuit so as to be in OR-relationship with the specified partial circuit, a rectangular area for one row is inserted into the lower side of the specified partial circuit to secure a pasting area of a size that allows the insertion of the partial circuit (procedure 3-1), the partial circuit is pasted on that one of the inserted rectangular areas which is located on the lower side of the specified partial circuit (procedure 3-2), and a connecting line is added so that the inserted partial circuit and the specified circuit are connected (procedure 3-3).

Thus, in the ladder program editor, the element or elements of the ladder circuit are handled simply as a figure in editing the ladder program, so that the following procedures are needed to insert the partial circuit as an object of pasting in an appropriate relationship with the existing ladder program in the partial circuit pasting operation.

Procedure (1)

Before starting pasting, an appropriate free area is secured in conformity to the circuit elements to be pasted.

Procedure (2)

The partial circuit is pasted on an appropriate rectangular area.

Procedure (3)

After the pasting, connecting lines are suitably added to complete the circuit.

The above procedures of the pasting operation are manually performed by an operator who is carrying out a ladder program editing operation in consideration of the arrangement of the circuit after the pasting. The operator can save the trouble of arranging the ladder elements one after another by pasting the partial circuit of the ladder on the ladder program. On the other hand, however, it is necessary to perform the above procedures in consideration of the relationship between the partial circuit to be pasted and the circuit already arranged in the ladder program. Therefore, if the situation is misjudged, an erroneous operation easily occurs such that the partial circuit is inserted into a wrong position or AND/OR relationship with an existing ladder circuit are wrongly inserted.

As described in Japanese Patent No. 5073067, an attempt has been made to perform a pasting operation somewhat automatically in inserting a partial circuit of a ladder into a ladder program. According to the prior art disclosed in this Japanese Patent No. 5073067, however, a logical expression corresponding to a specified partial circuit is inserted by using a logical expression for a ladder circuit as a pasting destination in the ladder program, and the display of the ladder circuit is reconstructed based on the inserted logical expression. Thus, the ladder program is not edited by the screen display only, so that the partial circuit sometimes cannot be pasted on a ladder circuit that does not allow transformation into the logical expression in the middle of editing.

### SUMMARY OF THE INVENTION

Accordingly, the object of the present invention is to provide a ladder program editor capable of appropriately pasting a partial circuit on a ladder program displayed on a screen, based on display elements of the ladder program.

According to the present invention, the above problems are solved by automatically appropriately pasting the partial circuit in the following procedures, in a pasting operation for pasting the partial circuit on the ladder program by means of the ladder program editor.

Procedure A1: Specification of the partial circuit as an object of pasting is accepted from an operator.

Procedure A2: Specification of an area (reference area) that serves as a reference for the pasting operation in a ladder circuit as a pasting destination and a pasting method (insertion to the left (or right) in AND and upward (or downward) insertion in OR) is accepted from the operator.

Procedure A3: The partial circuit is automatically pasted in the following procedures in accordance with the specified reference area and pasting method.

Procedure A3-1: A pasting area of a size that accommodates the partial circuit as the object of posting is inserted into an appropriate position.

Procedure A3-2: A circuit is pasted on the inserted pasting area.

Procedure A3-3: Horizontal and vertical lines are added according to the specified pasting method.

In the procedure A3-1 described above, columns and rows of rectangular areas are inserted into base point positions depending on the size of the partial circuit as the object of pasting, based on, as base points, the “lower left corner (right of the vertical connecting lines)” of the reference area if the pasting method is “insertion into the left side in AND” and the “lower right corner (left of the vertical connecting lines)” of the reference area for other cases. The connecting lines are interpolated for those parts of the inserted rectangular areas outside the range in which the circuit is pasted. Moreover, if the pasting method is “insertion in AND”, connecting lines are added between the reference area and the inserted columns within the ranges of selected areas.

Furthermore, in the above procedure A3-3, deletable connecting lines are deleted at the left and right ends of the pasted circuit if the pasting method is “insertion in AND”, and connecting lines are added to deficient parts if the pasting method is “insertion in OR” and if the partial circuit as the object of pasting is horizontally shorter than the reference area. Moreover, vertical connecting lines are added from the left and right ends of the pasted circuit toward the reference area within the range of the ladder circuit so that they are connected to any of the elements.

By automatically performing the above procedure A3, the partial circuit can be appropriately pasted on a ladder program displayed on a screen, based on display elements of the ladder program.

One aspect of the present invention is a ladder program editor configured to edit a ladder program, the ladder program editor comprising an editing control unit configured to manage a virtual drawing area or a space in which the ladder program is virtually located and which is formed as a set of a plurality of rectangular areas, a pasting object specifying unit configured to specify a partial circuit as an object of pasting, a reference area specifying unit configured to specify a reference area, in the virtual drawing area, to serve as a reference for pasting the partial circuit, a pasting method specifying unit configured to specify a pasting position and a pasting method for the partial circuit based on the reference area, a pasting area insertion unit configured to insert a pasting area for pasting the partial circuit into the virtual drawing area based on the pasting position and the pasting method specified by the pasting method specifying unit, a pasting processing unit configured to paste the partial circuit on the pasting area, and a connecting line adjustment unit configured to interpolate a connecting line or lines and delete a superfluous connecting line or lines in the virtual drawing area.

According to the present invention, in the pasting method for pasting the partial circuit of a ladder, it is necessary only that insertion in AND/OR be specified for the upper, lower, left and right parts of the specified partial circuit, so that an intuitive editing operation for the operator can be implemented. Moreover, necessary connecting lines can be automatically added during the insertion of the partial circuit, so that the operator can partially reduce the load of the editing operation. Furthermore, the partial circuit insertion operation can be performed even for a ladder circuit being created that cannot be logically expressed.

### BRIEF DESCRIPTION OF THE DRAWINGS

The above and other objects and features of the present invention will be obvious from the ensuing description of embodiments with reference to the accompanying drawings, in which:

FIG. 1 is a schematic hardware configuration diagram showing a principal part of a ladder program editor according to one embodiment of the present invention;

FIG. 2 is a schematic functional block diagram of the ladder program editor according to the one embodiment of the present invention;

FIG. 3 is a flowchart illustrating a processing flow in the case where “insertion into the lower side in OR” is specified as a pasting method;

FIG. 4 is a flowchart illustrating a processing flow in the case where “insertion into the upper side in OR” is specified as the pasting method;

FIG. 5 is a flowchart illustrating a processing flow in the case where “insertion into the left side in AND” is specified as the pasting method;

FIG. 6 is a flowchart illustrating a processing flow in the case where “insertion into the right side in AND” is specified as the pasting method;

FIG. 7 is a flowchart illustrating a flow of processing for inserting columns into the left side;

FIG. 8 is a flowchart illustrating a flow of processing for inserting columns into the right side;

FIG. 9 is a diagram showing an example of an insertion operation of the ladder program editor of the present invention for inserting a partial circuit into an incomplete ladder circuit;

FIG. 10 is a diagram showing another example of the insertion operation of the ladder program editor of the present invention for inserting the partial circuit into the incomplete ladder circuit;

FIG. 11 is a diagram showing another example of the insertion operation of the ladder program editor of the present invention for inserting the partial circuit into the incomplete ladder circuit;

FIG. 11 is a diagram showing an example of an insertion operation of the ladder program editor of the present invention for inserting a partial circuit into a plurality of contacts in OR-relationship;

FIG. 13 is a diagram snowing another example of the insertion operation of the ladder program editor of the present invention for inserting the partial circuit into the plurality of contacts in OR-relationship;

FIG. 14 is a diagram showing an example of a partial circuit pasting operation in prior art ladder program editing;

FIG. 15 is a diagram snowing another example of the partial circuit pasting operation in the prior art ladder program editing; and

FIG. 16 is a diagram showing another example of the partial circuit pasting operation in the prior art ladder program editing.

### DETAILED DESCRIPTION OF THE PREFERRED EMBODIMENTS

The following is a description of an embodiment of a ladder program editor for implementing the present invention. The embodiment of the ladder program editor of the present invention is not limited to the following example.

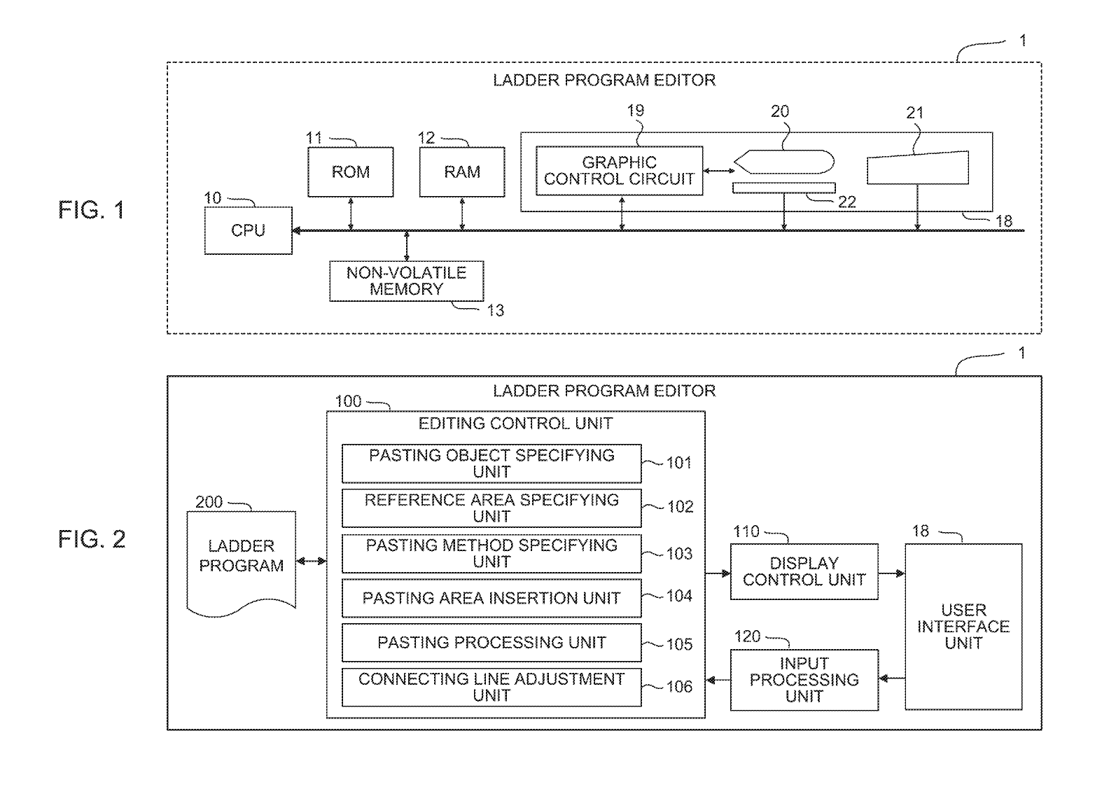

FIG. 1 is a hardware configuration diagram showing a principal part of a ladder program editor according to one embodiment of the present invention. A ladder program editor 1 can be constructed as a PC, numerical controller or the like.

The ladder program editor 1 is mainly composed of a CPU 10. The CPU 10 controls the entire ladder program editor 1 according to a system program stored in a ROM 11. An EPROM or EEPROM is used for the ROM 11.

A DRAM or the like is used for a RAM 12 and is loaded with temporary calculation data, display data, input/output signals and the like. A CMOS or SRAM, which is backed up by a battery (not shown), or a storage device such as an HDD or an SDD is used for a non-volatile memory 13 and is stored with parameters, ladder programs and the like so be retained even after the power supply is turned off.

A user interface unit 18 is used to display data and graphics, to input data, and to operate the ladder program editor 1. A graphic control circuit 19 converts digital signals, such as numerical data and graphic data, into raster signals for display and delivers them to a display device 20, which displays these numerical values and graphics. While a liquid-crystal display device is mainly used for the display device 20, any other display device may alternatively be used only if it can display the ladder program.

An input device 21 comprises a keyboard, which is provided with numeric keys, symbolic keys, character keys, and function keys, and a pointing device such as a mouse and is used to create and edit the ladder program, for example.

A touch panel 22 has the function of detecting touching and dragging operations by an operator. The touch panel 22 is disposed superimposed on the screen of the display device 20. The operator can detect, by means of the touch panel 22, operations on software keys, software buttons, and software switches displayed on the screen of the display device 20. The touch panel 22 is not a constituent element essential to the ladder program editor 1 but may be provided as required. Alternatively, the touch panel 22 and the display device 20 may be combined into a single unit.

FIG. 2 is a schematic functional block diagram of the ladder program editor according to the one embodiment of the present invention, in which a system program for implementing a ladder program editing function is performed by the ladder program editor 1 shown in FIG. 1. Functional blocks shown in FIG. 2 are implemented as the CPU 10 of the ladder program editor 1 shown in FIG. 1 performs the system program to control the operations of various parts of the ladder program editor 1. The ladder program editor 1 of the present embodiment comprises an editing control unit 100, display control unit 110, and input processing unit 120. Moreover, the editing control unit 100 comprises a pasting object specifying unit 101, reference area specifying unit 102, pasting method specifying unit 103, pasting area insertion unit 104, pasting processing unit 105, and connecting line adjustment unit 106.

The editing control unit 100 reads out a ladder program 200 from the non-volatile memory 13 and displays it on the user interface unit 18 through the display control unit 110. Moreover, the editing control unit 100 accepts the operator's input operation input from the user interface unit 18 through the input processing unit 120 and controls editing of the ladder program 200 based on the input operation. The editing control unit 100 manages a virtual drawing area in which a ladder diagram is virtually drawn as a set of a plurality of rectangular areas on a memory such as she RAM 12. Elements (contacts, coils, horizontal connecting lines, etc.) of a ladder circuit included in the ladder program 200 can be arranged individually in the rectangular areas, while vertical connecting lines can be arranged between the rectangular areas that are located side by side. The editing control unit 100 can display a part or the whole of the virtual drawing area as the ladder diagram on the user interface unit 18 by issuing a command to the display control unit 110. Furthermore, based on the operator's operation from the user interface unit 18, the editing control unit 100 can freely change the area(s) (one or a plurality of rectangular areas) in the virtual drawing area to be displayed as the ladder diagram on the user interface unit 18. Moreover, the editing control unit 100 can determine the area(s) (one or a plurality of rectangular areas) in the virtual drawing area for which the operator operates the ladder program 200 displayed as the ladder diagram on the user interface unit 18. The editing control unit 100 may be configured to manage the rows and columns of the rectangular areas constituting the virtual drawing area by putting signs on them. If this is done, the operator can perform an operation, for the area(s) (one or a plurality of rectangular areas) in the virtual drawing area by designating the signs put on the rows and columns of the rectangular areas through the user interface unit 18. By performing control on the display, operation and the like of the ladder program 200, the editing control unit 100 can accept the operator's input operation input from the user interface unit 18 for each of the elements (contacts, coils, horizontal connecting lines, etc.) of the ladder circuit included in the ladder program 200.

The pasting object specifying unit 101 is a function means for specifying a partial circuit to be pasted on the ladder program 200 as a pasting destination. The pasting object specifying unit 101 may be configured to form the partial circuit as an object of pasting by combining the elements of the ladder circuit, based on the operator's operation for the user interface unit 18, for example. Alternatively, the pasting object specifying unit 101 may be configured to select the partial circuit as the object of pasting out of the ladder program 200 displayed on the user interface unit 18. The pasting object specifying unit 101 may be configured to store the partial circuit specified as the object of pasting into a temporary storage area on, for example, the RAM 12, for storing the partial circuit as the object of pasting.

The reference area specifying unit 102 is a function means for specifying a reference area to serve as a reference for pasting the partial circuit as the object of pasting, out of the ladder program 200 displayed on the user interface unit 18. The reference area specifying unit 102 can specify the reference area based on at least one or more of the rectangular areas, out of the area occupied by the ladder program 200. The reference area specified by the reference area specifying unit 102 may be allowed to be specified by selecting some rectangular areas of the area in which the ladder program 200 is displayed by operating, for example, a pointing device, such as a cursor key or a mouse, in the user interface unit 18. Alternatively, the reference area may be allowed to be specified by inputting the signs put on the rows and columns of the rectangular areas. The reference area specifying unit 102 may be configured to store the specified reference area into a temporary storage area on, for example, the RAM 12, for storing the reference area.

The pasting method specifying unit 103 is a function means for specifying a method for pasting the partial circuit as the object of pasting specified by the pasting object specifying unit 101, based on the reference area specified as a reference by the reference area specifying unit 102. The pasting method specifying unit 103 can specify at least the direction (upward, downward, leftward, or rightward) in which the partial circuit as the object of pasting is pasted on the reference area and the relationship (AND/OR) in which the partial circuit as the object of pasting is pasted on the reference area, as the specifying method. The pasting method specifying unit 103 may be configured to be able to specify the pasting method by operating a menu or the like displayed on the user interface unit 18 or by operating a function key or the like, for example. The pasting method specifying unit 103 may be configured to store the specified pasting method into a temporary storage area on, for example, the RAM 12, for storing the pasting method.

The pasting area insertion unit 104 is a function means for inserting a pasting area for pasting the partial circuit as the object of pasting, based on the reference area in the virtual drawing area specified as a reference position by the reference area specifying unit 102. The pasting area insertion unit 104 inserts the columns and rows of the rectangular areas into base point positions depending on the size of the partial circuit as the object of pasting, based on, as base points, the “lower left corner” of the reference area if the pasting method specified by the pasting method specifying unit 103 is “insertion into the left side in AND”, the “upper right corner” of the reference area if the specified pasting method is “insertion into the upper side in OR”, and the “lower right corner” of the reference area for other cases. If vertical connecting lines are drawn between the reference area and the rectangular areas outside the reference area in inserting the columns, the pasting area insertion unit 104 inserts the columns of the rectangular areas between the connecting lines (vertical lines) and the reference area.

The pasting processing unit 105 is a function means for pasting the partial circuit as the object of pasting on the pasting area in the virtual drawing area inserted by the pasting area insertion unit 104. If the pasting method specified by the pasting method specifying unit 103 is “insertion into the left side in AND” or “insertion into the right side in AND”, the pasting processing unit 105 pastes the partial circuit as the object of pasting on the pasting area so that the respective upper sides of the reference area and the partial circuit as the object of pasting are aligned with each other. Moreover, if the pasting method specified by the pasting method specifying unit 103 is “insertion into the lower side in OR” or “insertion info the upper side in OR”, the pasting processing unit 105 pastes the partial circuit as the object of pasting on the pasting area so that the respective left sides of the reference area and the partial circuit as the object of pasting are aligned with each other.

The connecting line adjustment unit 106 is a function means for adjusting (interpolating and deleting) the connecting lines drawn between the circuits when the pasting area is inserted by the pasting area insertion unit 104 and when the partial circuit as the object of pasting is inserted into the pasting area by the pasting processing unit 105. The connecting line adjustment unit 106 interpolates the connecting lines divided by the pasting area for the rectangular areas outside the range in which the circuit in the inserted pasting area is pasted when the pasting area is inserted by the pasting area insertion unit 104. Moreover, the connecting line adjustment unit 106 interpolates the vertical connecting lines divided by the insertion, by the pasting area insertion unit 104, of the columns of the rectangular areas between the reference area and the connecting lines (vertical lines) drawn between the rectangular areas, between the reference area and the inserted columns within the ranges of the selected areas.

Furthermore, the connecting line adjustment unit 106 deletes superfluous connecting lines at the left and right ends of the pasted circuit if the pasting method is “insertion in AND” when the partial circuit as the object of pasting is inserted into the pasting area by the pasting processing unit 105. If the pasting method is “insertion in OR” and if the partial circuit as the object of pasting is horizontally shorter than the reference area, the connecting line adjustment unit 106 interpolates horizontal connecting lines to deficient parts. Moreover, the connecting line adjustment unit 106 adds vertical connecting lines from the left and right ends of the pasted circuit toward the reference area within the range of the ladder circuit so that they are connected to any of the elements.

The following is an illustration of processing performed by the individual function means of the editing control unit 100.

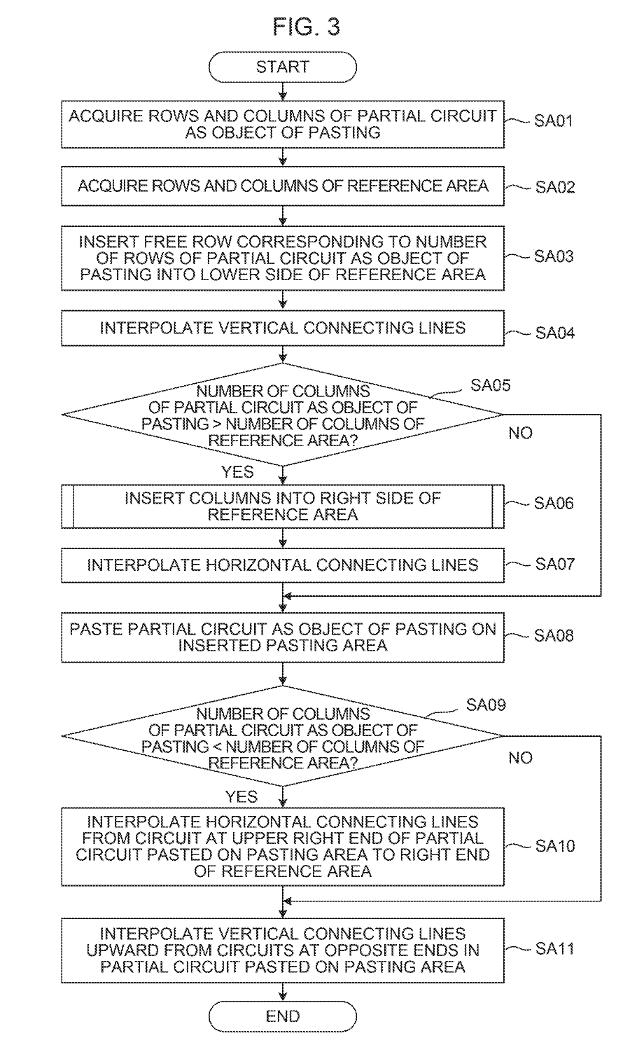

FIG. 3 is a flowchart illustrating a processing flow in the case where “insertion into the lower side in OR” is specified as the pasting method, in processing performed by the function means of the editing control unit 100.

[Step SA01]

The pasting area insertion unit 104 acquires the rows and columns of the partial circuit as the object of pasting.

[Step SA02]

The pasting area insertion unit 104 acquires the rows and columns of the reference area.

[Step SA03]

The pasting area insertion unit 104 inserts a free row corresponding to the number of rows of the partial circuit as the object of pasting into the lower side of the reference area.

[Step SA04]

The connecting line adjustment unit 106 interpolates the vertical connecting lines divided by the insertion of the free row.

[Step SA05]

The pasting area insertion unit 104 determines whether or not the number of columns of the partial circuit as the object of pasting is larger than that of the reference area. If the number of columns of the partial circuit as the object of pasting is larger than that of the reference area, the processing proceeds to Step SA06. If not, the processing proceeds to Step SA08.

[Step SA06]

The pasting insertion unit 104 performs processing for inserting columns into the right side of the reference area. Details of this processing will be described later.

[Step SA07]

The connecting line adjustment unit 106 interpolates the horizontal connecting lines divided by the insertion of the free row.

[Step SA08]

The pasting processing unit 105 pastes the partial circuit as the object of pasting on the inserted pasting area.

[Step SA09]

The connecting line adjustment unit 106 determines whether or not the number of columns of the partial circuit as the object of pasting is smaller than that of the reference area. If the number of columns of the partial circuit as the object of pasting is smaller than that of the reference area, the processing proceeds to Step SA10. If not, the processing proceeds to Step SA11.

[Step SA10]

The connecting line adjustment unit 106 interpolates the horizontal connecting lines from the circuit at the upper right end in the partial circuit pasted on the pasting area to the right end of the reference area.

[Step SA11]

The connecting line adjustment unit 106 interpolates the vertical connecting lines upward from the circuits at opposite ends in the partial circuit pasted on the pasting area.

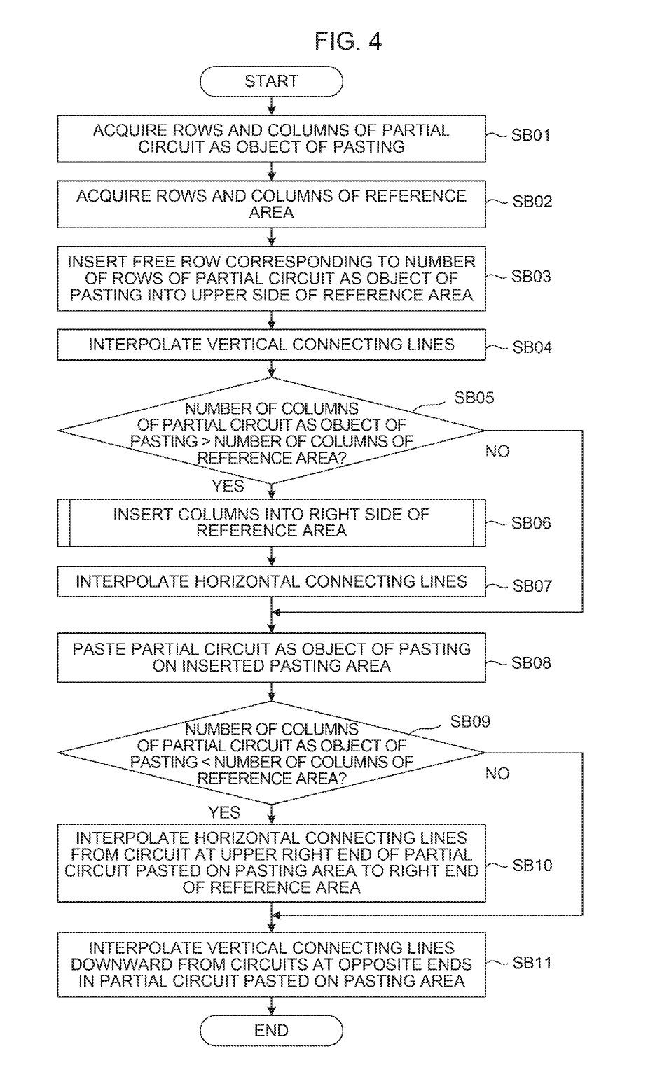

FIG. 4 is a flowchart illustrating a processing flow in the case where “insertion into the upper side in OR” is specified as the pasting method, in processing performed by the function means of the editing control unit 100.

[Step SB01]

The pasting area insertion unit 104 acquires the rows and columns of the partial circuit as the object of pasting.

[Step SB02]

The pasting area insertion unit 104 acquires the rows and columns of the reference area.

[Step SB03]

The pasting area insertion unite 104 inserts a free row corresponding to the number of rows of the partial circuit as the object of pasting into the upper side of the reference area.

[Step SB04]

The connecting line adjustment unit 106 interpolates the vertical connecting lines divided by the insertion of the free row.

[Step SB05]

The pasting area insertion unit 104 determines whether or not the number of columns of the partial circuit as the object of pasting is larger than that of the reference area. If the number of columns of the partial circuit as the object of pasting is larger than that of the reference area, the processing proceeds to Step SB06. If not, the processing proceeds to Step SB08.

[Step SB06]

The pasting area insertion unit 104 performs processing for inserting columns into the right side of the reference area. Details of this processing will be described later.

[Step SB07]

The connecting line adjustment unit 106 interpolates the horizontal connecting lines divided by the insertion of the free row.

[Step SB08]

The pasting processing unit 105 pastes the partial circuit as the object of pasting on the inserted pasting area.

[Step SB09]

The connecting line adjustment unit 106 determines whether or not the number of columns of the partial circuit as the object of pasting is smaller than that of the reference area. If the number of columns of the partial circuit as the object of pasting is smaller than that of the reference area, the processing proceeds to Step SB10. If not, the processing proceeds to Step SB11.

[Step SB10]

The connecting line adjustment unit 106 interpolates the horizontal connecting lines from the circuit at the upper right end in the partial circuit pasted on the pasting area to the right end of the reference area.

[Step SB11]

The connecting line adjustment unit 106 interpolates the vertical connecting lines downward from the circuits at opposite ends in the partial circuit pasted on the pasting area.

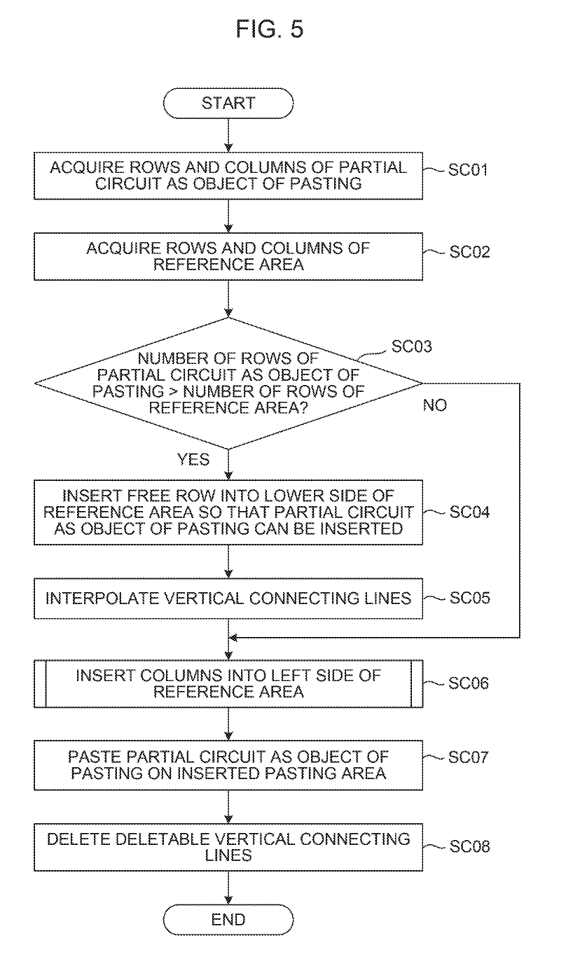

FIG. 5 is a flowchart illustrating a processing flow in the case where “insertion into the left side in AND” is specified as the pasting method, in processing performed by the function means of the editing control unit 100.

[Step SC01]

The pasting area insertion unit 104 acquires the rows and columns of the partial circuit as the object of pasting.

[Step SC02]

The pasting area insertion unit 104 acquires the rows and columns of the reference area.

[Step SC03]

The pasting area insertion unit 104 determines whether or not the number of rows of the partial circuit as the object of pasting is larger than that of the reference area. If the number of rows of the partial circuit as the object of pasting is larger than that of the reference area, the processing proceeds to Step SC04. If not, the processing proceeds to Step SC06.

[Step SC04]

The pasting area insertion unit 104 inserts a free row into the lower side of the reference area so that the partial circuit as the object of pasting can be inserted.

[Step SC05]

The connecting line adjustment unit 106 interpolates the vertical connecting lines divided by the insertion of the free row.

[Step SC06]

The pasting area insertion unit 104 performs processing for inserting columns into the left side of the reference area. Details of this processing will be described later.

[Step SC07]

The pasting processing unit 105 pastes the partial circuit as the object of pasting on the inserted pasting area.

[Step SC08]

The connecting line adjustment unit 106 deletes deletable vertical connecting lines.

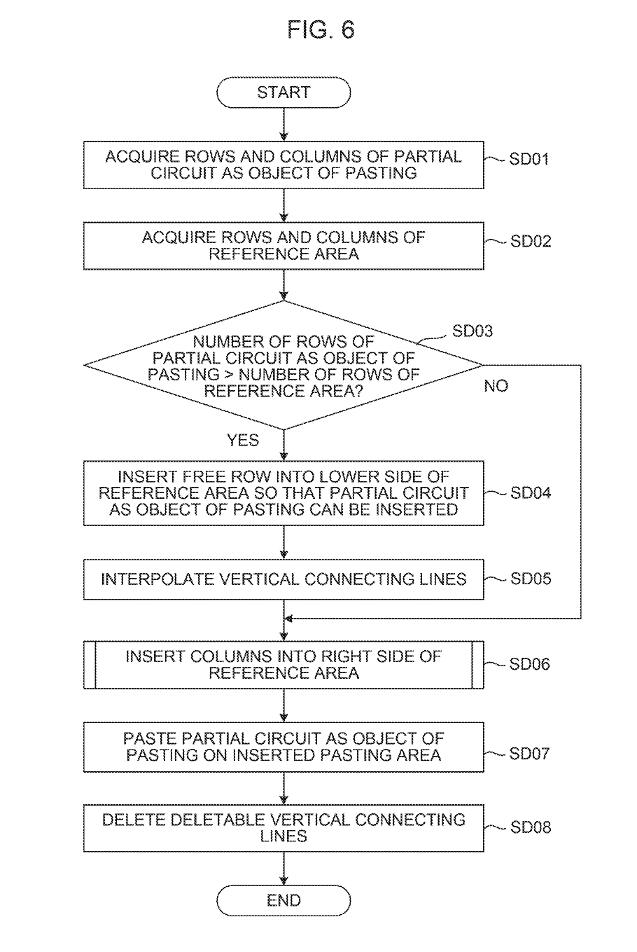

FIG. 6 is a flowchart illustrating a processing flow in the case where “insertion into the right side in AND” is specified as the pasting method, in processing performed by the function means of the editing control unit 100.

[Step SD01]

The pasting area insertion unit 104 acquires the rows and columns of the partial circuit as the object of pasting.

[Step SD02]

The pasting area insertion unit 104 acquires the rows and columns of the reference area.

[Step SD03]

The pasting area insertion unit 104 determines whether or not the number of rows of the partial circuit as the object of pasting is larger than that of the reference area. If the number of rows of the partial circuit as the object of pasting is larger than that of the reference area, the processing proceeds to Step SD04. If not, the processing proceeds to Step SD06.

[Step SD04]

The pasting area insertion unit 104 inserts a free row into the lower side of the reference area so that the partial circuit as the object of pasting can be inserted.

[Step SD05]

The connecting line adjustment unit 106 interpolates the vertical connecting lines divided by the insertion of the free row.

[Step SD06]

The pasting area insertion unit 104 performs processing for inserting columns into the right side of the reference area. Details of this processing will be described later.

[Step SD07]

The pasting processing unit 105 pastes the partial circuit as the object of pasting on the inserted pasting area.

[Step SD08]

The connecting line adjustment unit 106 deletes deletable vertical connecting lines.

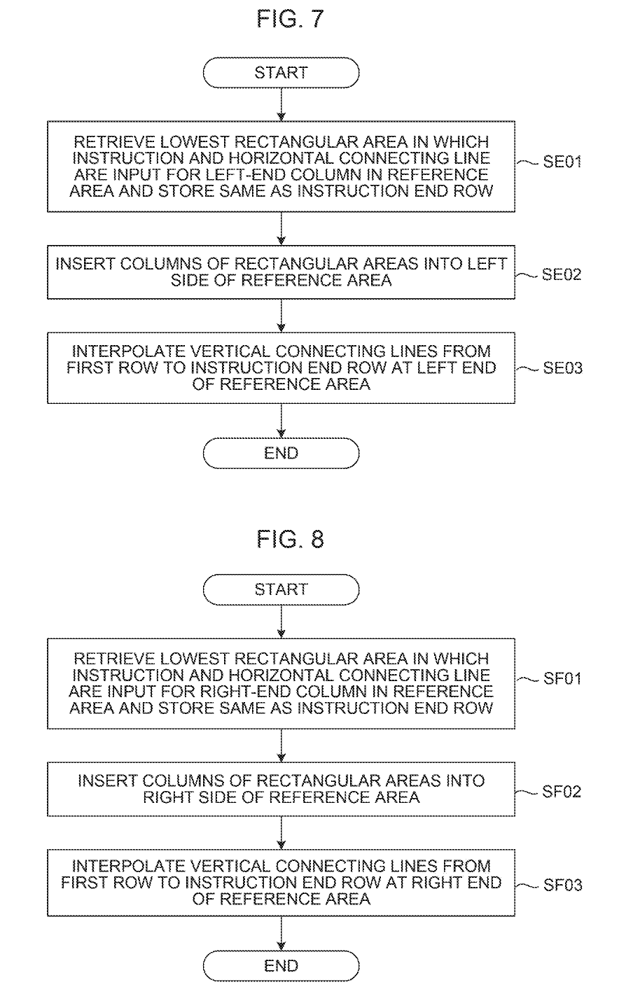

FIG. 7 is a flowchart illustrating a flow of processing for inserting columns into the left side.

[Step SE01]

The pasting area insertion unit 104 retrieves the lowest rectangular area in which an instruction and a horizontal connecting line are input for the left-end column in the reference area and stores it as an instruction end row.

[Step SE02]

The pasting area insertion unit 104 inserts columns into the left side of the reference area. If vertical connecting lines are drawn between the reference area and the rectangular areas outside the reference area in inserting the columns, the pasting area insertion unit 104 inserts the columns of the rectangular areas between the connecting lines (vertical lines) and the reference area.

[Step SE03]

The connecting line adjustment unit 106 interpolates the vertical connecting lines from a first row to the instruction end row at the left end of the reference area.

FIG. 8 is a flowchart illustrating a flow of processing for inserting columns into the right side.

[Step SF01]

The pasting area insertion unit 104 retrieves the lowest rectangular area in which an instruction and a horizontal connecting line are input for the right-end column in the reference area and stores it as an instruction end row.

[Step SF02]

The pasting area insertion unit 104 inserts columns into the right side of the reference area. If vertical connecting lines are drawn between the reference area and the rectangular areas outside the reference area in inserting the columns, the pasting area insertion unit 104 inserts the columns of the rectangular areas between the connecting lines (vertical lines) and the reference area.

[Step SF03]

The connecting line adjustment unit 106 interpolates the vertical connecting lines from the first row to the instruction end row at the right end of the reference area.

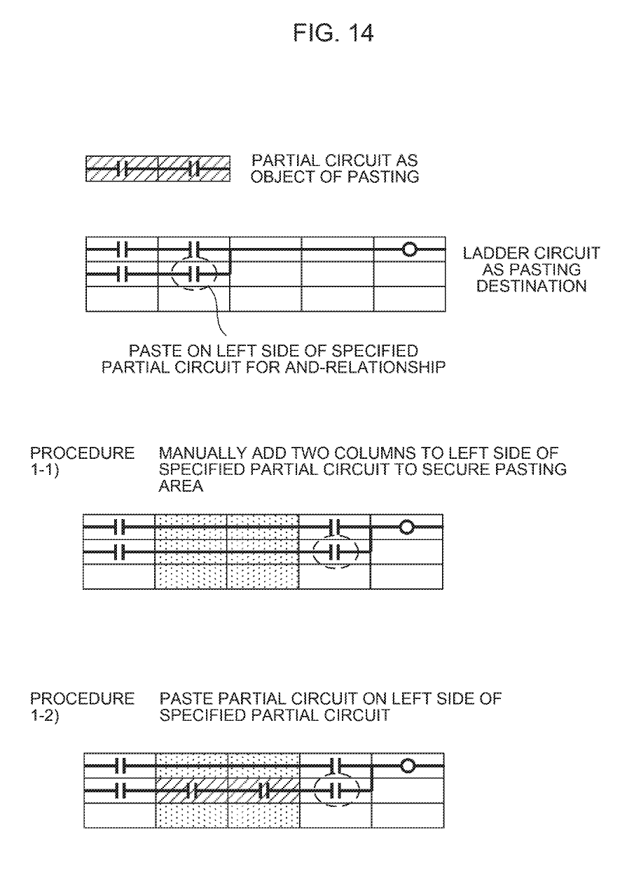

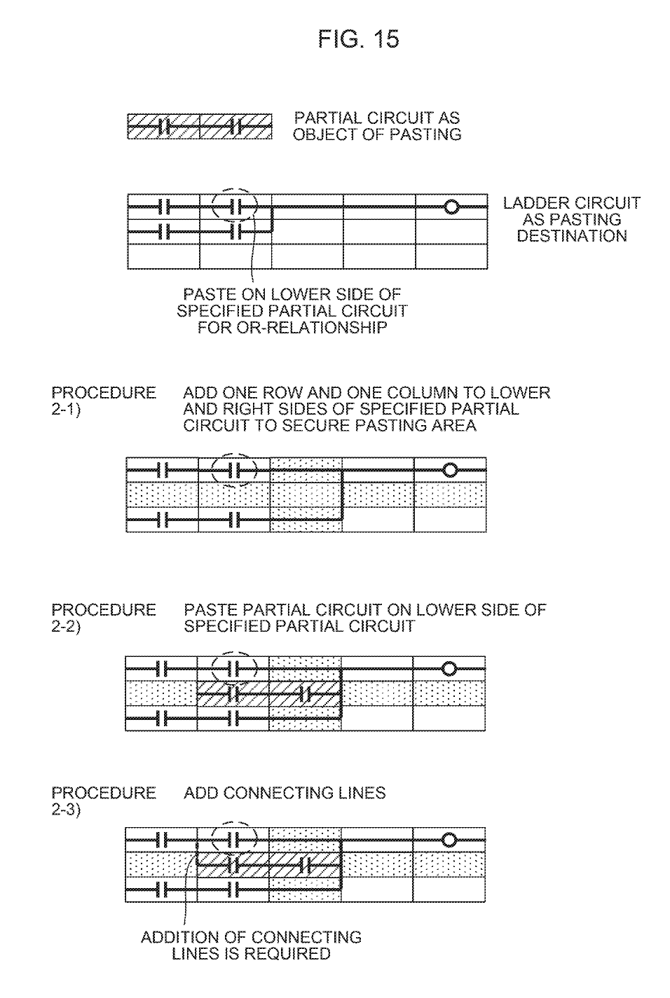

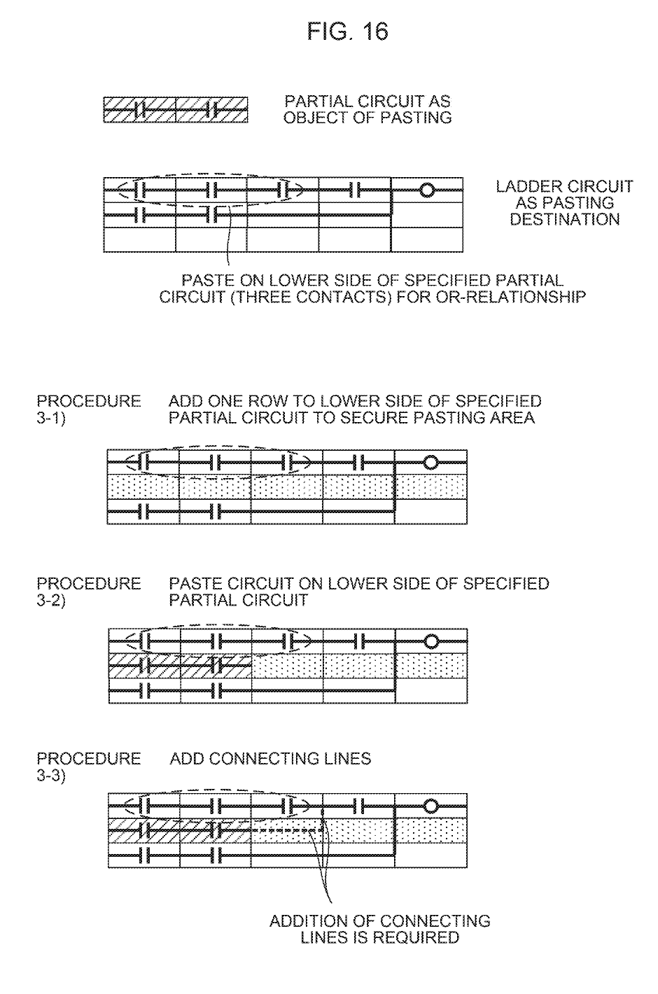

According to the ladder program editor 1 of the present embodiment described above, the insertion of the pasting area and the interpolation of the connecting lines, which have so far been performed manually, are performed automatically in the partial circuit pasting operation in the prior art ladder program editing shown in FIGS. 14 to 16, so that the burden on the operator who creates the ladder program can be reduced.

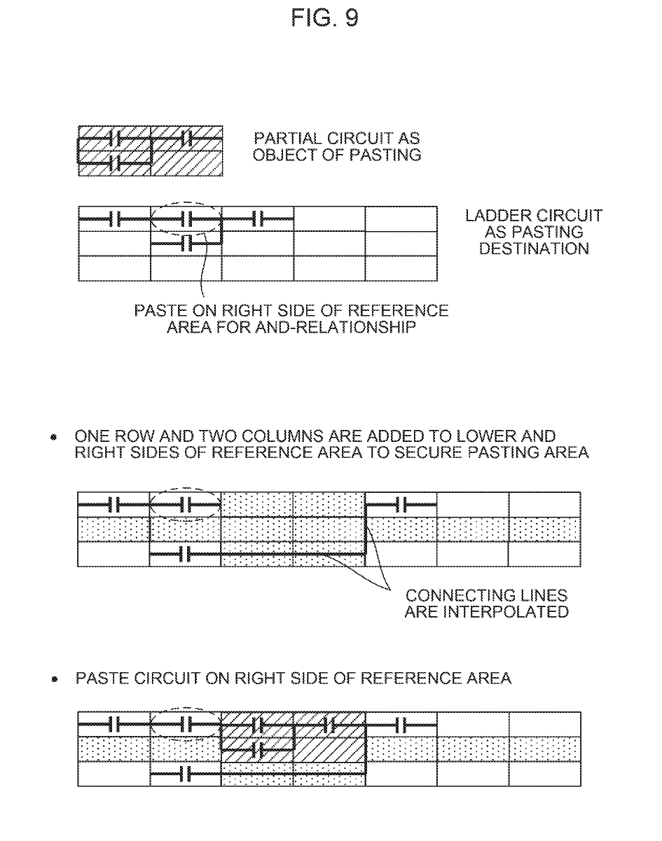

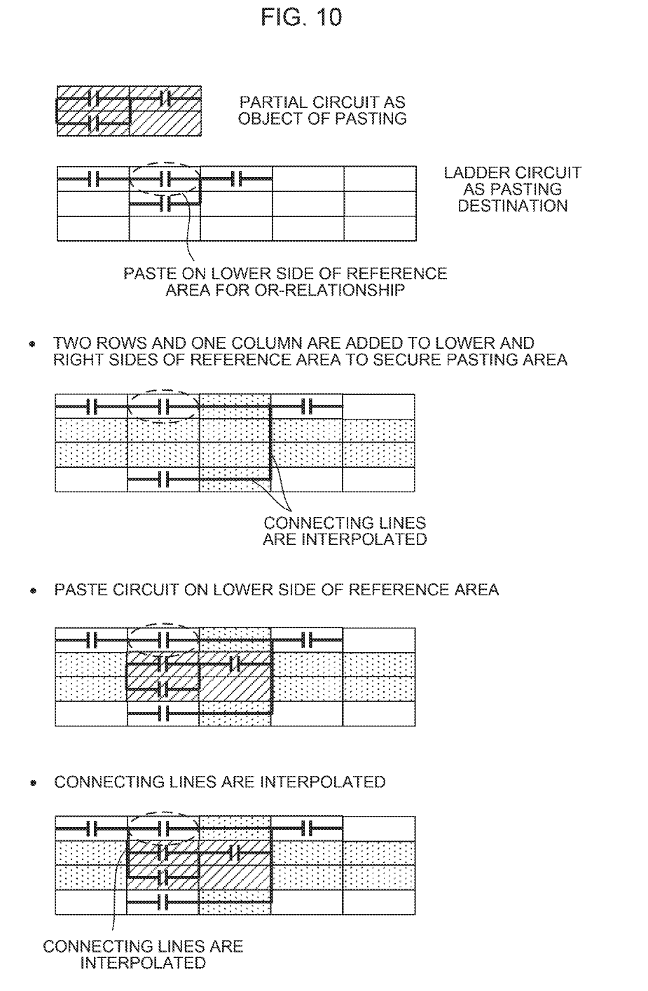

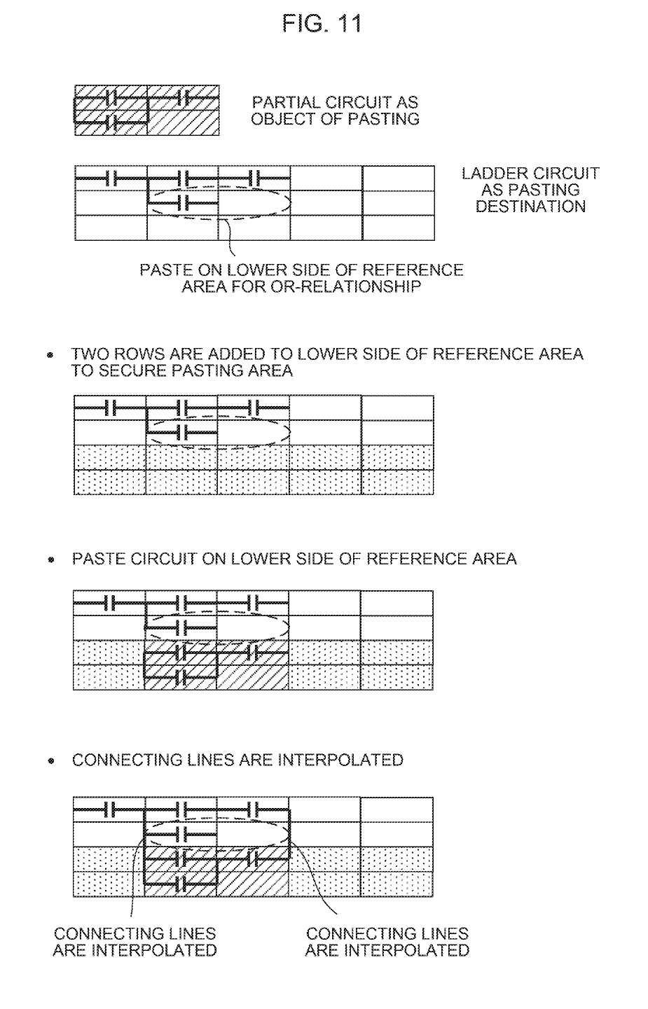

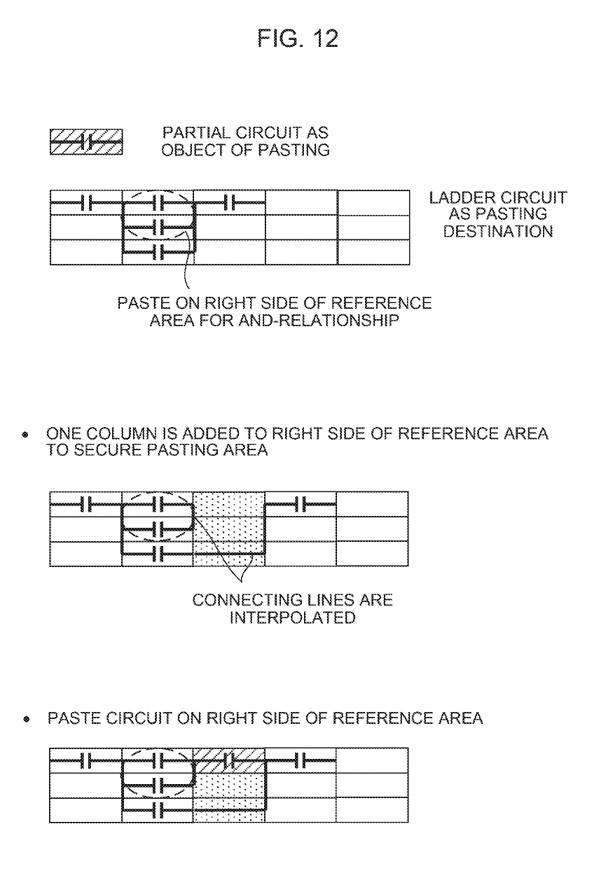

In the ladder program editor 1 of the present embodiment, as described above, the partial circuit can be inserted into the ladder circuit by processing on the virtual drawing area in which the ladder diagram is drawn. Therefore, as illustrated in FIGS. 9 to 11, the partial circuit can be inserted into the ladder circuit in the middle of editing. In the case of FIG. 9, for example, the logical relationship between a first-row, first-column contact and a second-row, second-column contact is not determined in the ladder circuit as the pasting destination, so that the insertion processing cannot be performed using a logical expression. However, according to the ladder program editor 1 of the present embodiment, the partial circuit can be inserted into an incomplete ladder circuit by securing the pasting area in the virtual drawing area, pasting the partial circuit, and interpolating the connecting lines.

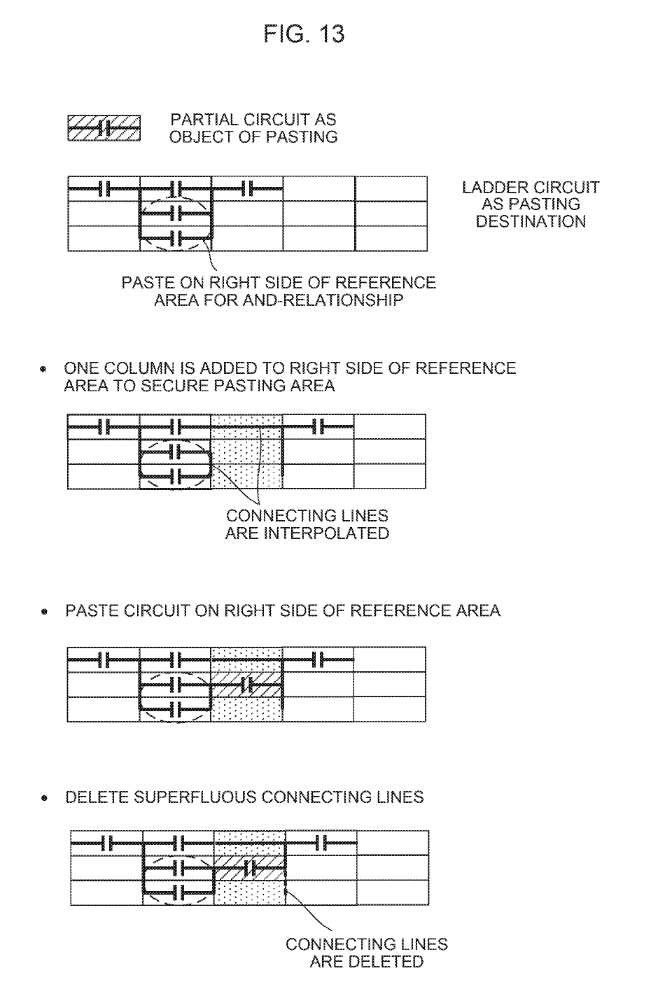

Moreover, in the ladder program editor 1 of the present embodiment, as described above, the partial circuit can be inserted into the ladder circuit by the processing on the virtual drawing area in which the ladder diagram is drawn. Therefore, as illustrated in FIGS. 12 and 13, the partial circuit of which the relationship with a specified contact is defined can easily be inserted into a plurality of contacts in OR-relationship. In FIG. 12, the partial circuit is inserted into two upper ones of three contacts in OR-relationship so as to be in AND-relationship with them. In FIG. 13, the partial circuit is inserted into two lower ones of the three contacts in OR-relationship so as to be in AND-relationship with them. In either case, it can be ascertained that the partial circuit can be inserted in an appropriate configuration.

While an embodiment of the present invention has been described herein, the invention is not limited to the above-described embodiment and may be suitably modified and embodied in other forms.

1. A ladder program editor configured to edit a ladder program, the ladder program editor comprising:
an editing control unit configured to manage a virtual drawing area or a space in which the ladder program is virtually located and which is formed as a set of a plurality of rectangular areas;
a pasting object specifying unit configured to specify a partial circuit as an object of pasting;
a reference area specifying unit configured to specify a reference area, in the virtual drawing area, to serve as a reference for pasting the partial circuit;
a pasting method specifying unit configured to specify a pasting position and a pasting method for the partial circuit based on the reference area;
a pasting area insertion unit configured to insert a pasting area for pasting the partial circuit into the virtual drawing area based on the pasting position and the pasting method specified by the pasting method specifying unit;
a pasting processing unit configured to paste the partial circuit on the pasting area; and
a connecting line adjustment unit configured to interpolate a connecting line or lines and delete a superfluous connecting line or lines in the virtual drawing area.
